(19) United States
(12) Patent Application Publication
(10) Pub. No.: US 2024/0009852 A1
(43) Pub. Date: Jan. 11, 2024

(54) LOCAL SENSOR UNITS FOR MANUFACTURING CELLS

(71) Applicant: Path Robotics, Inc., Columbus, OH (US)

(72) Inventors: Andrew Ryan LIEN, Columbus, OH (US); Alex KOENIG, Columbus, OH (US); Stephen CRIBB, Galena, OH (US); Siqi HUANG, Dublin, OH (US); Jason ROBINSON, Columbus, OH (US); Derlin CHOW, Dublin, OH (US)

(21) Appl. No.: 18/347,711

(22) Filed: Jul. 6, 2023

Related U.S. Application Data
(60) Provisional application No. 63/358,802, filed on Jul. 6, 2022.

(51) Int. Cl. B25J 9/16; B25J 11/00; B25J 19/00; B25J 15/00; B23K 9/095

(52) U.S. Cl. CPC B25J 9/1697; B25J 11/005; B25J 19/0054; B25J 15/0019; B23K 9/0953

(57) ABSTRACT

A manufacturing cell for welding a workpiece includes a robotic arm extending between a base and a terminal end, a weld head coupled to the terminal end of the robotic arm such that the weld head is permitted to travel relative to the base of the robotic arm, wherein the weld head is configured to weld the workpiece, a sensor pod coupled to the weld head and including an outer pod housing defining an internal chamber extending between a front end and a rear end of the pod housing, and wherein the front end of the pod housing defines a receptacle, a sensor positioned in the internal chamber of the pod housing, the sensor configured to provide sensor feedback associated with the workpiece, and a consumable window including a transparent material is insertable into the receptacle such that a longitudinal axis of the sensor intersects the consumable window when the consumable window is inserted into the receptacle, and a controller coupled to the sensor pod and configured to operate at least one of the robotic arm and the weld head based on the sensor feedback provided by the sensor of the sensor pod.

### CROSS-REFERENCE TO RELATED APPLICATIONS

This application claims benefit of U.S. provisional patent application Ser. No. 63/358,802, filed Jul. 6, 2022, which is incorporated herein by reference herein in its entirety.

### BACKGROUND

Manufacturing or “work” cells may comprise self-contained cellular units including a robot or robotic arm having an instrument or manufacturing tool such as, for example, a welding tool, a cutting tool, a drilling tool, a gripper, etc. connected thereto and which operates or “works” on an object or workpiece secured within the manufacturing cell. These self-contained manufacturing cells provide an avenue through which robotics may be leveraged in manufacturing or fabrication processes. It may be understood that workpieces operated on by the robotic arms of manufacturing cells may vary significantly in shape, size, materials, etc. The manufacturing cell may also include one or more sensors for monitoring the workpiece and/or manufacturing tool attached to the robotic arm, and a control system or controller which controls the operation of the robotic arm and/or manufacturing tool based on feedback received from the one or more sensors of the manufacturing cell. The manufacturing cell may also include a platform for physically supporting the robotic arm, controller, one or more sensors, and a positioner used to position the workpiece relative to the robotic arm.

### BRIEF SUMMARY OF THE DISCLOSURE

An embodiment of a manufacturing cell for welding a workpiece comprises a robotic arm extending between a base and a terminal end, a weld head coupled to the terminal end of the robotic arm such that the weld head is permitted to travel relative to the base of the robotic arm, wherein the weld head is configured to weld the workpiece, a sensor pod coupled to the weld head and comprising an outer pod housing defining an internal chamber extending between a front end and a rear end of the pod housing, and wherein the front end of the pod housing defines a receptacle, a sensor positioned in the internal chamber of the pod housing, the sensor configured to provide sensor feedback associated with the workpiece, and a consumable window comprising a transparent material is insertable into the receptacle such that a longitudinal axis of the sensor intersects the consumable window when the consumable window is inserted into the receptacle, and a controller coupled to the sensor pod and configured to operate at least one of the robotic arm and the weld head based on the sensor feedback provided by the sensor of the sensor pod. In some embodiments, the sensor pod is coupled to the weld head such that the sensor pod is configured to travel in concert with the weld head relative to the base of the robotic arm. In some embodiments, the longitudinal axis projects from the sensor of the sensor pod towards a terminal end of the weld head. In certain embodiments, the sensor of the sensor pod comprises at least one of a laser configured to project a light onto the workpiece, and a camera configured to record imaging data of the workpiece. In certain embodiments, the sensor pod comprises a retainer coupled to the front end of the pod housing and configured to retain the consumable window in the receptacle. In some embodiments, the retainer of the sensor pod comprises a spring clip having a first end coupled to the front end of the pod housing and a free end, opposite the first end, that is permitted to flex outwardly from the front end of the pod housing. In some embodiments, the retainer of the sensor pod comprises a closure tab having a first end pivotably coupled to the front end of the pod housing and a free end, opposite the first end, configured to rotate relative to the pod housing. In certain embodiments, the sensor pod comprises a spray nozzle coupled to the front end of the pod housing, the spray nozzle configured to direct a flow of fluid towards the consumable window when the consumable window is inserted in the receptacle. In certain embodiments, the front end of the pod housing comprises a transparent window comprising a transparent material, and wherein the transparent window is positioned between the sensor and the consumable window along the longitudinal axis when the consumable window is inserted in the receptacle. In some embodiments, the consumable window of the sensor pod is removably insertable into the receptacle of the pod housing. In some embodiments, the sensor pod comprises a plurality of the consumable windows, each removably insertable into the receptacle of the pod housing. In certain embodiments, the receptacle of the sensor pod is external the internal chamber of the sensor pod housing. In certain embodiments, the manufacturing cell comprises a coolant circulation module comprising a coolant source and one or more fluid conduits coupled between the coolant source and a coolant inlet of the pod housing of the sensor pod whereby fluid communication is provided between the coolant source and the internal chamber of the pod housing, wherein the coolant circulation module is configured to circulate a coolant from the coolant source, through the one or more fluid conduits, and into the internal chamber of the pod housing via the coolant inlet.

An embodiment of a manufacturing cell for welding a workpiece comprises a robotic arm extending between a base and a terminal end, a weld head coupled to the terminal end of the robotic arm such that the weld head is permitted to travel relative to the base of the robotic arm, wherein the weld head is configured to weld the workpiece, a sensor pod coupled to the weld head and comprising an outer pod housing defining an internal chamber extending between a front end and a rear end of the pod housing, the pod housing comprising a coolant inlet in fluid communication with the internal chamber, and a sensor positioned in the internal chamber of the pod housing, the sensor configured to provide sensor feedback associated with the workpiece, a coolant circulation module comprising a coolant source and one or more fluid conduits coupled between the coolant source and the coolant inlet of the pod housing of the sensor pod whereby fluid communication is provided between the coolant source and the internal chamber of the pod housing, wherein the coolant circulation module is configured to circulate a coolant from the coolant source, through the one or more fluid conduits, and into the internal chamber of the pod housing via the coolant inlet, and a controller coupled to the sensor pod and configured to operate at least one of the robotic arm and the weld head based on the sensor feedback provided by the sensor of the sensor pod. In some embodiments, the pod housing of the sensor pod comprises a coolant vent in fluid communication with the internal chamber, and wherein the coolant vent is configured to vent fluid from the internal chamber into the atmosphere. In some embodiments, the manufacturing cell comprises a plurality of the sensor pods each coupled to the weld head, and wherein the coolant source of the coolant circulation module is in fluid communication with the internal chamber of each of the plurality of sensor pods. In certain embodiments, the sensor pod is coupled to the weld head such that the sensor pod is configured to travel in concert with the weld head relative to the base of the robotic arm. In some embodiments, the longitudinal axis projects from the sensor of the sensor pod towards a terminal end of the weld head. In some embodiments, the sensor of the sensor pod comprises at least one of a laser configured to project a light onto the workpiece, and a camera configured to record imaging data of the workpiece. In certain embodiments, the front end of the pod housing of the sensor pod defines a receptacle, and the sensor pod further comprises a consumable window comprising a transparent material is insertable into the receptacle such that a longitudinal axis of the sensor intersects the consumable window when the consumable window is inserted into the receptacle. In certain embodiments, the sensor pod comprises a window retainer coupled to the front end of the pod housing and configured to retain the consumable window in the receptacle.

### BRIEF DESCRIPTION OF THE DRAWINGS

For a detailed description of various exemplary embodiments, reference will now be made to the accompanying drawings in which:

FIG. 1 is front view of an embodiment of a manufacturing cell;

FIG. 2 is a front view of an embodiment of a local sensor unit of a manufacturing cell;

FIG. 3 is a perspective, partial cross-sectional view of the local sensor unit of FIG. 2;

FIGS. 4 and 5 are front views of another embodiment of a local sensor unit of a manufacturing cell;

FIG. 6 is a side, partial cross-sectional view of the local sensor unit of FIGS. 4 and 5;

FIG. 7 is a front view of another embodiment of a local sensor unit of a manufacturing cell;

FIG. 8 is a rear view of the local sensor unit of FIG. 7;

FIG. 9 is another front view of the local sensor unit of FIG. 7; and

FIG. 10 is a perspective view of the local sensor unit of FIG. 7.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form, and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

As previously described, manufacturing cells may be utilized to leverage robotics in different manufacturing and fabrication processes and may generally include a robotic arm, a positioner for positioning a workpiece operated on by the robotic arm, one or more sensors, a controller, and a platform for physically supporting the components of the manufacturing cell including, for example, the robotic arm, a sensor unit comprising one or more sensors, and the positioner. The sensors of the manufacturing cell may determine a relative position of a tool (e.g., a cutting tool, a weld head, etc.) carried by the robotic arm relative to a workpiece to be operated on by the tool. As an example, manufacturing cells may include a global sensor unit positioned on a platform of the manufacturing cell that includes sensors for monitoring the workpiece, and a local sensor unit coupled to the tool carried by the robotic arm and which may identify or detect surface features of the workpiece such as seams to be welded by a welding tool carried by the robotic arm.

The operation of the tool carried by the robotic arm of the manufacturing cell may generate a large amount of heat and may generate hazardous waste in the form of hot cuttings and weld splatter, as a few examples, that may splatter or otherwise contact the one or more sensor units of the manufacturing cell. For example, the heat generated by the operation of the tool carried by the robot may transfer to sensitive electronic equipment of the one or more sensor units, potentially overheating the electronic equipment and thereby damaging or otherwise interfering with the operation the electronic equipment. Additionally, hazardous materials produced by the tool may come into contact with surfaces of the one or more sensor units, potentially damaging the sensor unit. As an example, weld splatter produced by a weld head carried by the robotic arm may fall upon a camera lens or transparent window of the sensor unit used to provide a sensor (e.g., a laser, a camera) with a line of site of the weld head and/or work piece. The weld splatter may adhere to the lens or window and thereby obscure the line of site provided to the sensor and thereby interfere with the operation of the sensor.

Accordingly, embodiments of manufacturing cells are described herein which include a sensor unit including a sensor pod including a sensor protected by the sensor pod from the surrounding environment, including conditions in the surrounding environment created by the operation of a tool carried by a robotic arm of the manufacturing cell. For example, the sensor pod is configured to protect the sensor from heat generated by the operation of the tool, as well as from materials produced by the operation of the tool which may come into contact with the sensor pod such as cuttings and weld splatter.

Particularly, embodiments of sensor pods are described herein which include an outer pod housing defining an internal chamber within which the sensor is positioned. The internal chamber may be cooled by a coolant circulation module of the manufacturing cell configured to circulate a coolant (e.g., air) from a coolant source to the internal chamber of the pod housing via one or more fluid conduits of the coolant circulation module. In this manner, heat transferred to the sensor may be transferred to the surrounding environment using the coolant circulating into and out of the internal chamber of the pod housing.

In some instances, the sensor may comprise a laser, camera, or other sensor which is positioned within a line of sight of the tool carried by the robotic arm and/or workpiece operated on by the tool. The pod housing of embodiments of sensor pods described herein thus may include solid windows intended to protect the sensor from the external environment while permitting the tool and/or workpiece to fall into a field of view (FOV) of the sensor. Particularly, the sensor pod may include a sacrificial, consumable window which is insertable into an aperture defined by the pod housing. The consumable window may be formed from a solid transparent material and positioned between the sensor and the tool such that materials ejected from the tool and/or workpiece such as cuttings or weld splatter may fall upon or splatter onto the consumable window. In this manner, the consumable window may be routinely replaced as foreign materials are deposited onto the consumable window, negating the need to clean or redress the window for subsequent future use. Additionally, in some embodiments, the sensor pod may include a spray nozzle configured to direct a stream of fluid towards the consumable window so as to remove foreign materials from the consumable window as the tool of the manufacturing cell operates on a workpiece.

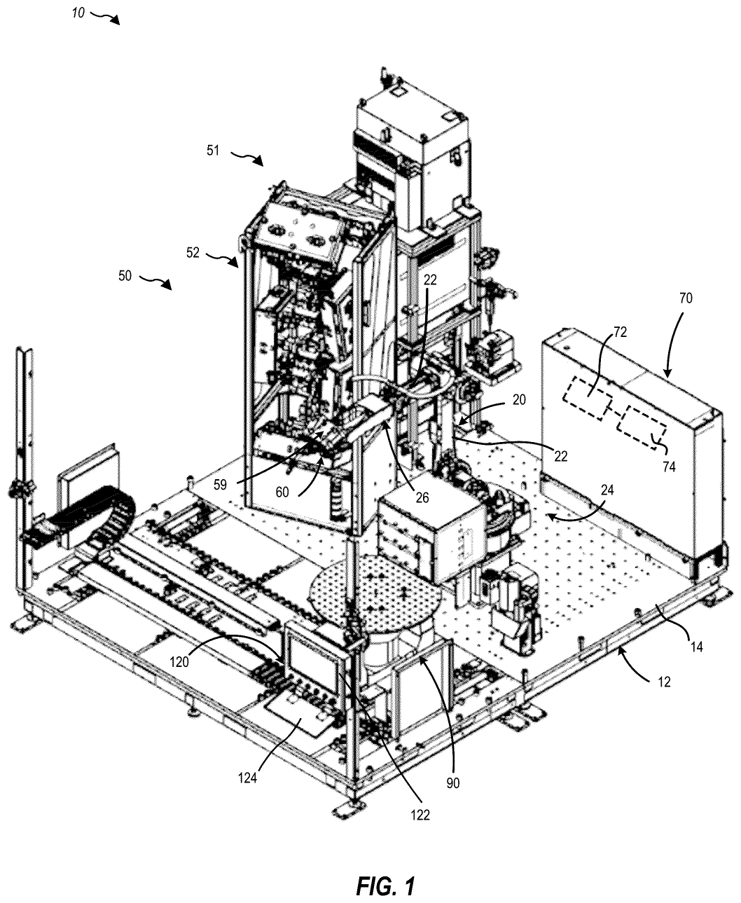

Referring now to FIG. 1, an embodiment of a transportable manufacturing cell 10 including a modular support platform 12 is shown. In this exemplary embodiment, manufacturing cell 10 generally includes a platform 12, a robotic arm 20, a sensor unit 50, a control system or controller 70, a positioner unit 90, an input/output (I/O) unit 120, an enclosure 130, and the support platform 12. It may be understood that the configuration of manufacturing cell 10 may vary in other embodiments, and thus cell 10 may include equipment in addition to that shown in FIG. 1.

The platform 12 of manufacturing cell 10 physically supports components of the cell including, for example, the robotic arm 20, sensor unit 50, controller 70, positioner unit and I/O unit 120. Particularly, platform 12 transfers loads from the components of manufacturing cell 10 such as, for example, loads due to the weight of the components and/or dynamic loads resulting from the operation of robotic arm 20, positioner unit 90. It may be understood that in other embodiments manufacturing cell 10 may not include a separate platform 12 and instead components of cell 10 may be supported directly on a manufacturing floor.

In this exemplary embodiment, platform 12 generally includes a support pad or base 14 positionable on a support surface such as a manufacturing floor. Support pad 14 directly supports components of manufacturing cell 10 including, for example, the robotic arm 20 and sensor unit 50. In some embodiments, platform 12 may additionally include an outer walled enclosure extending around at least a portion of the perimeter of the manufacturing cell 10. Platform 12 may be transportable from an assembly site (in a pre-assembled or a fully assembled state) to a manufacturing site via a variety of means.

The robotic arm 20 of manufacturing cell 10 operates on an object or workpiece positioned or held by the positioner unit 90 of manufacturing cell 10. In this exemplary embodiment, robotic arm 20 generally includes a plurality of articulated arms or links 22 coupled between a base 24 and a terminal end 26 of the robotic arm 20 which is opposite the base 24. Links 22 are pivotably coupled together along the length of robotic arm 20 to provide the terminal end 26 of robotic arm 20 with one or more degrees of freedom (DOF) (e.g., six degrees of freedom (6DOF) in some embodiments) relative to the base 24. For example, links 22 may be coupled end-to-end via a plurality of servos or rotary joints. The base 24 of robotic arm 20 is rotatably attached or mounted to a robot mount 30. Robot mount 30 is connected between robotic arm 20 and the support platform 12 of manufacturing cell 10. In this exemplary embodiment, robotic arm 20 comprises an articulated robotic arm; however, it may be understood that in other embodiments the configuration of robotic arm 20 may vary. For example, in other embodiments, robotic arm 20 may comprise a cartesian robotic arm, a selective compliance assembly robot arm (SCARA), a delta robotic arm, a polar robotic arm, etc.

Additionally, a tool 40 is connected to the terminal end 26 of robotic arm 20 opposite the base 24 thereof. Tool 40 is manipulated by robotic arm 20 to operate on the workpiece held by positioner unit. In this exemplary embodiment, tool 40 comprises a weld head 40 which may be operated to weld the workpiece held by the positioner unit 90. The weld head 40 may perform various types of welding including, for example, seam welding, and may comprise various components for performing welding including a torch and/or other equipment. While in this exemplary embodiment tool 40 comprises a weld head, in other embodiments, various other types of tools may be attached to the terminal end 26 of robotic arm. For example, in other embodiments, tool 40 may comprise a cutting tool, a drill, a gripper, a grinder, and/or other tools.

Sensor unit 50 of manufacturing cell 10 provides sensor feedback to the controller for operating the robotic arm 20, weld head 40, and/or positioner unit 90. Sensor unit 50 may comprise a variety of different types of sensors mounted at various locations for different purposes, and only some of the sensors of sensor unit 50 may be described herein. In this exemplary embodiment, sensor unit 50 includes a global sensor unit 51 comprising one or more global or workpiece sensors 52 to monitor the workpiece held by positioner unit 90, and a local sensor unit 59 comprising one or more local or tool sensors 60.

In this exemplary embodiment, global sensors 52 of global sensor unit 51 monitor the workpiece held by positioner unit 90 while the local sensors 60 of local sensor unit 59 monitor the tool 40 attached to robotic arm 20. For example, global sensors 52 may monitor a position, orientation, condition, surface features, and/or other phenomena associated with the workpiece and/or positioning unit 90. Local sensors 60 may in-turn monitor a position, orientation, condition, and/or other phenomena associated with the tool 40. Local sensor unit 59 is coupled terminal end 26 of the robotic arm 20 and thus is free to move relative to both the global sensor unit 51 and the platform 12 by one or more DOFs (6 DOFs in some embodiments). In this exemplary embodiment, global sensors 52 and/or local sensors 60 comprise optical sensors or cameras (e.g., high frame rate video cameras), laser sensors, positioning sensors, and/or other types of sensors. Additionally, in some embodiments, sensor unit 50 may not include both global sensor unit 51 and local sensor unit 59. Instead, for example, sensor unit 50 may include only the local sensor unit 59 and not the global sensor unit 51.

As described above, the controller 70 of manufacturing cell 10 operates the robotic arm 20, weld head 40, and/or positioner unit 90 using feedback provided by sensor unit 50. Controller 70 generally includes a processor or central processing unit (CPU) and a memory device 74 (each shown schematically in FIG. 1) which stores instructions executable by the CPU 72. It may be understood that CPU 72 may comprise one or more separate processors and memory device 74 may comprise one or more memory devices. Additionally, while controller 70 is shown on-board the support platform 12 of manufacturing cell, it may be understood that in other embodiments at least a portion of the controller 70 may be off-board. For example, in some embodiments, at least some components of the controller 70 may be positioned at a locate remote of the other components of manufacturing cell 10 (e.g., robotic arm 20, positioner unit 90, support platform 12) and may communicate with components of cell 10 via a network.

In some embodiments, controller 70 may operate components of the manufacturing cell 10 autonomously in accordance with instructions stored on the memory device 74. As an example, the CPU 72 of controller 70 may execute a machine learning algorithm including a computer vision algorithm in which the controller 70 autonomously performs a welding operation on a workpiece held by the positioner unit 90 using the robotic arm 20, tool 40, sensor unit 50, and positioner unit 90. Broadly, the controller 70 may autonomously determine a position and orientation of a workpiece to be welded held by the positioner unit 90 using the global sensors 52 of sensor unit 50. Controller 70 may also particularly autonomously identify a seam of the workpiece to be welded using the global sensors 52 of sensor unit 50. Controller 70 may operate the robotic arm 20, tool 40, lasers, artificial light sources, and/or positioner unit 90 to weld the identified seam using both global sensors 52 and local sensors 60 of sensor unit 50.

As described above, the positioner unit 90 of manufacturing cell 10 positions and/or holds an object or workpiece in a desired position and at a desired orientation. In this exemplary embodiment, positioner unit 90 comprises a positioner 100 extending between a positioner base 102 mounted to the support platform 12 and a connector 104 of the positioner 100. In this exemplary embodiment, base 102 comprises a rotatable mount allowing positioner 100 to rotate about a longitudinal axis thereof relative to the support platform 12. It may be understood that in other embodiments the connection formed between positioner 100 and the support platform 12 by base 102 may vary in configuration. In this exemplary embodiment, the connector 104 comprises a planar stage 104 mounted to the support platform 12. In this exemplary embodiment, one or more workpieces may be positioned on, and potentially secured to, the stage 104 of positioner unit 90. The controller 70 of manufacturing cell 10 may operate the robotic arm 20, weld head 40, and/or positioner unit 90 based on command inputs provided to the controller 70 by an operator of manufacturing cell 10 using the I/O unit 120 of cell 10. For example, the operator of manufacturing cell 10 may input a command to the I/O unit 120 to initiate a desired operational sequence executable by the controller 70 to weld or otherwise operate on a workpiece held by the positioner unit 90 of the manufacturing cell 10. In this exemplary embodiment, I/O unit 120 comprises a display 122 and an input (e.g., a keypad or other input) 124 from which an operator may both input command signals to the controller 70 and monitor an operational status of the manufacturing cell 10. In some embodiments, the operator of manufacturing cell 10 may directly control the operation of components of cell 10 including, for example, robotic arm 20, tool 40, sensor unit 50, and/or positioner unit 90.

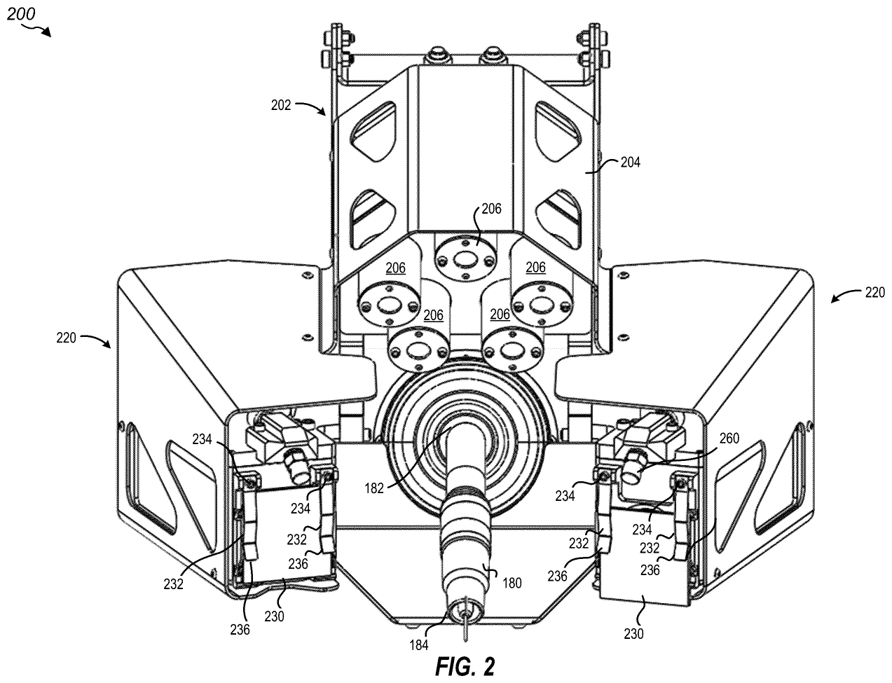

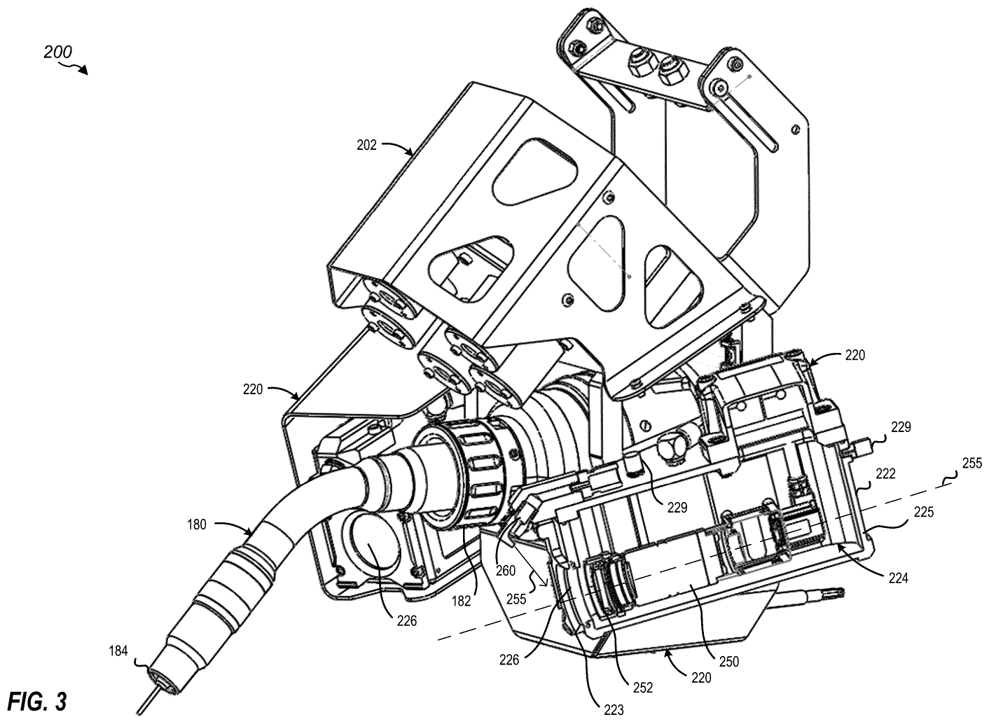

Referring now to FIGS. 2 and 3, an embodiment of a local sensor unit 200 is shown. Local sensor unit 59 of the sensor unit 50 briefly described above may be configured similarly as the local sensor unit 200 described below. In this exemplary embodiment, local sensor unit 200 (e.g., its various components, individually or in combination) is configured to be coupled to a weld head 180. Local sensor unit 200 generally includes a laser pod 202 and a pair of camera pods 220 (also referred to herein as sensor pods 220) each configured to be coupled to the weld head 180. Weld head 180 extends along a central or longitudinal axis from a first end or base 182 to a second end or tip 184 opposite the base 182. The tip 184 of weld head 180 may comprise an electrode, a nozzle, and/or other equipment for welding a workpiece including, for example, performing a seam weld on the workpiece. Additionally, the base 182 of weld head 180 is configured to connect to the terminal end 26 of robotic arm 20 such that robotic arm 20 may desirably position the weld head 180 relative to a workpiece to be welded on by the weld head 180.

In some implementations, laser pod 202 and camera pods 220 may be coupled to each other and mounted around the centrally positioned weld head 180 and provide sensor feedback to the controller 70 of manufacturing cell 10. In this exemplary embodiment, laser pod 202 comprises an outer pod housing 204 and one or more generally cylindrical scanning lasers 206 at least partially received in the pod housing 204. Scanning lasers 206 are oriented in the direction of the tip 184 of weld head 180 and are generally configured to project a laser light onto a workpiece to scan the workpiece as the weld head 180 welds the workpiece. As will be discussed further herein, light projected by artificial light sources may be received by the camera pods 220 to assist the camera pods 220 and controller 70 in identifying one or more surface features of the workpiece, including a position of a seam of a weld relative to the weld head 180. As will also be discussed further herein, laser light projected by the scanning lasers 206 may be received by the camera pods 220 to assist the camera pods 220 and controller 70 in identifying one or more surface features of the workpiece, including a position of a seam of a weld relative to the weld head 180. Although local sensor unit 200 is shown as including a plurality of scanning laser 206, in other embodiments, local sensor unit 200 may include a varying number of scanning lasers 206 including a single scanning laser 206. In still other embodiments, local sensor unit 200 may not include laser pod 202.

In some implementations, the laser pod 202 may be equipped with one or more artificial light sources (e.g., light-emitting diodes (LEDs)) instead of scanning lasers 206. The one or more artificial light sources, securely housed within the outer pod housing 204, can be configured to illuminate (e.g., project light onto) the workpiece. This light is to provide adequate illumination for the camera pods 220 to capture images of the workpiece. While the workpiece is illuminated, the camera pods 220 may be configured to operate to image the workpiece, enabling the identification of surface features and relative positioning of the weld seam. The one or more artificial light sources when used, direct their illumination onto the same portion of the workpiece that the camera pods 220 are configured to observe. This is to say, the direction of the one or more artificial light sources' illumination is aligned with the camera's field of view, ensuring a concurrent focus on the same area of the workpiece. This alignment allows for synchronous illumination and imaging, wherein both the light sources and camera pods 220 are directed at, and actively engaged with, the same segment of the workpiece at any given time. In some implementations, the one or more artificial light sources, such as LEDs, may not be confined within the outer pod housing 204 of the laser pod 202. Instead, these artificial light sources can be integrated into the camera pods 220. For example, each camera pod within the set of camera pods 220 may be designed to house its own set of one or more artificial light sources. In operation, these LEDs, when used, are directed to illuminate the same portion of the workpiece that the camera pods 220 are configured to image. That is, the direction of the LED illumination is aligned with the camera's field of view, ensuring a concurrent focus on the same area of the workpiece. This synchronous illumination and imaging allows each camera pod to independently project light onto and capture images of the same area of the workpiece at the same time.

Note that the light emitted from LEDs is different from the laser light emitted from lasers. LEDs emit incoherent, multi-directional light in a variety of colors, making them suitable for illumination with a more diffused light output. In other words, the light LEDs produce comes from electroluminescence and is not synchronized, resulting in a diffused output. On the other hand, lasers emit coherent, highly directional, and monochromatic light. That is, the light waves are synchronized and focused into a narrow beam.

Camera pods 220 capture image data of the workpiece and weld head 180 and provide that captured image data to the controller 70 as sensor feedback. As described above, part of the image data captured by camera pods 220 includes the laser light projected by the scanning lasers 206 of laser pod 202. Particularly, laser light projected by scanning lasers 206 is reflected off of the weld head 180 and the workpiece before being received and captured by camera pods 220. In some embodiments, camera pods 220 are configured to detect the polarization angle of the laser light projected by scanning lasers 206. In this manner, camera pods 220 may utilize the reflected laser light projected by scanning lasers 206 to more accurately determine the relative position between weld head 180 and one or more salient surface features of the workpiece, including a seam of the workpiece to be welded by the weld head 180.

In this exemplary embodiment, local sensor unit 200 comprises a pair of camera pods 220 (also referred to herein as “sensor pods”) flanking the centrally positioned weld head 180 in a stereoscopic arrangement with one camera pod 220 being positioned to the right of weld head 180 while the other camera pod 220 is positioned to the left of the weld head 180. It may however be understood that in other embodiments local sensor unit 200 may comprise a single camera pod 220 or more than two camera pods 220.

In this exemplary embodiment, each camera pod 220 generally includes an outer pod housing 222, a high-speed camera 250 received within the pod housing 222, a spray nozzle 260, and a circulation module 290. Briefly, camera 250 comprises a camera lens 252 and is oriented along a longitudinal sensor axis 255 of the camera 250. Sensor axis 255 need not be a central axis of the camera 250 itself, and instead may be a central axis of a component of the camera 250, such as a lens of the camera 250 through which the weld head 180 may be observed. Camera axis 255 extends generally in the direction of the tip 184 of the weld head 180 and is configured to intersect the workpiece when weld head 180 is engaged in a welding operation such that the workpiece remains in a field of view (FOV) of the camera 250 during the welding operation.

As shown particularly in FIG. 3, pod housing 222 has a first or front end 223 near the tip 184 of weld had 180 and a second or rear end 225 opposite the front end 223 and distal the tip 184 of weld head 180. Pod housing 220 defines an internal camera chamber 224 extending between the front end 223 and the rear end 225 in which the camera 250 is received. Additionally, pod housing 220 comprises a transparent opening or window 226 located at the front end 223. Transparent window 226 is filled with a transparent material such as glass, sapphire, etc. to protect the camera 250 housed within the pod housing 220.

A substantial amount of heat may be generated during the welding process as a workpiece is welded on by the weld head 180. The substantial heat generated during the welding process may radiate against components of the local sensor unit 200, heating the components of unit 200. Additionally, hot, liquefied material (e.g., liquified metal or alloy material) referred to as “weld splatter” may also be produced during the welding process and which may land on or otherwise contact components of the local sensor unit 200 in proximity with the weld head 180 and workpiece. It may be understood that sensitive electronic equipment of local sensor unit 200 must be shielded from the substantial heat and weld splatter generated during the welding process to ensure the electronic equipment does not become damages or otherwise impaired by the conditions produced during the welding operation including the presence of excessive heat and weld platter. Pod housings 222 of the camera pods 220 are configured to protect or shield the cameras 250 thereof from the harsh conditions (e.g., heat, weld splatter, etc.) present within the proximity of weld head 180 during the performance of a welding operation by the weld head 180.

Particularly, in this exemplary embodiment, the pod housing 222 of each camera pod 220 includes a coolant inlet 227 and a coolant outlet 229 (shown in FIG. 3) that is spaced from the coolant inlet 227. Coolant inlet 227 and coolant outlet 229 may be connected to a coolant circulation module (described further herein) for circulating a fluid coolant into the camera chamber 224 of pod housing 222 via coolant inlet 227 where the coolant may contact or otherwise receive heat from the camera 250 located within the camera chamber 224 so as to cool the camera 250. Having exchanged heat with the camera 250, the coolant is exhausted from the camera chamber 224 via the coolant outlet 229. The coolant may be recycled or ejected to the surrounding atmosphere after venting through coolant outlet 229. The coolant circulated through camera chamber 224 to cool camera 250 may comprise air at ambient conditions or other fluids. Additionally, the coolant may be chilled or otherwise conditioned before entering the camera chamber 224 via the coolant inlet 227.

Additionally, in this exemplary embodiment, the pod housing 222 of each camera pod 220 includes a replaceable or consumable window 230 positioned external the camera chamber 224 of pod housing 222 and over the transparent window 226 formed in pod housing 222. Particularly, transparent windows 226 are generally aligned with the camera axes 255 of cameras 250 such that camera axes 255 intersect the transparent windows 226. In this exemplary embodiment, consumable windows 230 are generally planar and plate-shaped, and comprise a transparent material to permit light to transmit through the consumable window 230 and into the camera 250 received within the camera chamber 224 of pod housing 220. Consumable windows 230 may comprise a relatively inexpensive transparent material such as a polymer-based material like plastic with the idea that consumable windows 230 are to be replaced periodically or following a predetermined number of welding operations performed by the weld head 180. In this manner, inexpensive materials rather than more expensive exotic or temperature resistant materials may be relied on for protecting the cameras 250 of camera pods 220.

As described above, consumable windows 230 are releasably coupled to the pod housings 222 of camera pods 220 such that consumable windows 230 may be quickly and conveniently replaced between separate welding operations performed by the weld head 180. In this exemplary embodiment, the pod housing 222 of each camera pod 220 comprises one or more releasable fasteners 234 for coupling the consumable windows 230 to the pod housings 222 of camera pods 220. In this exemplary embodiment, releasable fasteners 234 comprise spring clips and thus may also be referred to herein as spring clips 234 (hidden from view in FIG. 3). Each spring clip 234 has a first or fixed end 235 and a second or free end 236 opposite the fixed end 235 that is permitted to flex or more relative to the pod housing 222. An operator of manufacturing cell may manually slidably insert a consumable window 230 into an opening formed between a pair of the spring clips 234 and the transparent window 226 of one of the camera pods 220. For convenience, one of the consumable windows 230 is shown in FIG. 2 only partially inserted (the window 230 on the right of FIG. 2) into its respective opening (windows 230 are entirely hidden from view in FIG. 3 for clarity). The insertion of the consumable window 230 into the opening flexes the free ends 236 of the spring clips 234 outwardly away from the pod housing 222 with the free ends 236 of the spring clips 234 biased into frictional contact with the consumable window 230 to thereby releasably secure or couple the consumable window to the pod housing 222.

Spring clips 234 permit for the quick manual replacement of consumable windows 230 without the requirement of additional tooling. While each camera pod 220 is shown as including a pair of spring clips 234, in other embodiments, the number of spring clips 234 per camera pod 220 may vary. It may also be understood that the releasable fasteners 234 of each camera pod 220 may comprise a mechanism other than spring clips for releasably coupling a consumable window 230 to the pod housing 222. For example, in other embodiments, releasable fasteners 234 may comprise one or more threaded fasteners, one or more snap fittings or snap connectors, magnetic connectors, etc.

As described above, liquified materials in the form of weld splatter may be generated during at least some welding operations involving weld head 180. Particularly, weld splatter may splatter or fall upon various surfaces of the local sensor unit 200 located in proximity with the weld head 180. For example, weld splatter may fall upon the consumable windows 230 during the performance of a welding operation by weld head 180. The weld splatter, if not removed, may interfere with the performance of the camera 250 received within the pod housing 222 of the camera module 220. For example, weld splatter on the consumable window 230 may obstruct the view of the camera 250 with respect to the workpiece being welded on by the weld head 180. In implementations where the artificial light source is housed within the pod housing 222 (that is, the artificial light source is incorporated within the camera pods 220), consumable windows (windows similar to consumable windows 230) can be releasably coupled to the pod housings 222, thereby preventing weld splatter from reaching the artificial light sources. In some implementations, windows 230 may be big enough to prevent weld splatter from reaching both the cameras and the artificial light sources. In implementations where the artificial light source is housed in a different housing separate from pod housing 222, windows similar to the consumable windows 230 can be releasably coupled to those specific housings. These windows serve the same protective function, preventing weld splatter from damaging the artificial light sources, regardless of their location.

The spray nozzle 260 of each camera pod 220 is configured to spray or direct a continuous jet or spray of fluid (indicated by arrows 265 in FIG. 3) extending towards the consumable window 230 of the camera pod 220 so as to continuously clean any weld splatter or other materials from the surface of consumable window 230 during the performance of a welding operation by the weld head 180. The spray nozzle 260 of each camera pod 220 is coupled to the pod housing 222 thereof at the front end 223. The spray nozzles 260 of camera pods 220 are fluidically connected to a pressurized fluid source (not shown in FIGS. 2 and 3) from which spray nozzles 260 receive a continuous supply of pressurized fluid. The pressurized fluid dispersed by spray nozzles 260 comprises air in this exemplary embodiment, but it may be understood that the pressurized fluid may comprise or contain various types of liquids or gases in other embodiments.

It may be understood that in some embodiments the camera pods 220 of local sensor unit 200 may not include either a consumable window 230 and/or the spray nozzle 260. For example, in some embodiments, camera pod 220 may not include consumable window 230 or releasable fasteners 234 and instead may rely only on the transparent window 226 of pod housing 222 for protecting the camera 250 received therein. The fluid jet 265 emitted by the spray nozzle 260 may act directly against the transparent window 226 to continuously clean the window 226 of foreign materials (e.g., weld splatter) during the performance of a welding operation by the weld head 180. In still other embodiments, the camera pod 220 may not include both the consumable window 230 and the spray nozzle 260.

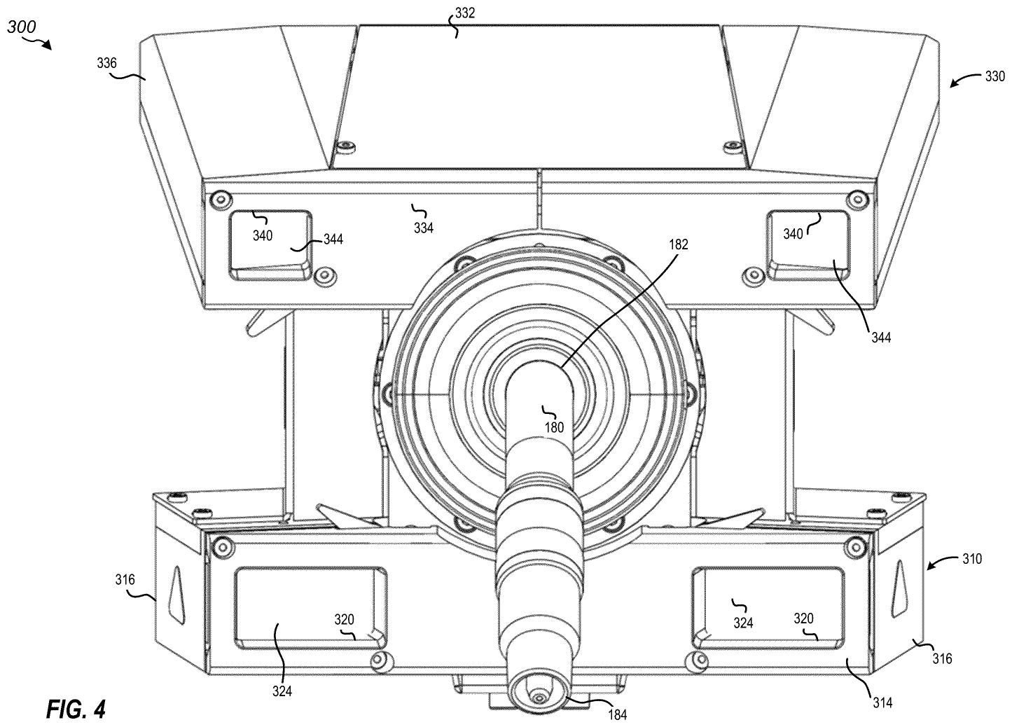

Referring to FIGS. 4-6, another embodiment of a local sensor unit 300 is shown. Local sensor unit 300 may include features in common with local sensor unit 200 shown in FIGS. 2 and 3, and shared features are labeled similarly. Local sensor unit 59 of the sensor unit 50 briefly described above may be configured similarly as the local sensor unit 300 described below. In this exemplary embodiment, local sensor unit 300 generally includes laser pod 310, a camera pod 330, and a coolant circulation module 360 each coupled or mounted to the weld head 180 described above.

The laser pod 310 of local sensor unit 300 generally includes an outer pod housing 312 defining an internal chamber 313 in which a plurality of lasers 315 are received. Lasers 315 may be similar in configuration to the lasers 206 described above and are oriented in the direction of the tip 184 of weld head 180 so as to illuminate or scan a workpiece being welded upon by the weld head 180. Pod housing 312 has a first or front end 314, a second or rear end 316 opposite the front end 314. In this exemplary embodiment, the front end 314 of pod housing 312 comprises a plurality of transparent windows 318 each aligned with a corresponding laser 315 of the laser pod 310. Transparent windows 318 are filled with a transparent material which may be of a similar configuration as the transparent material filling the transparent windows 226 described above.

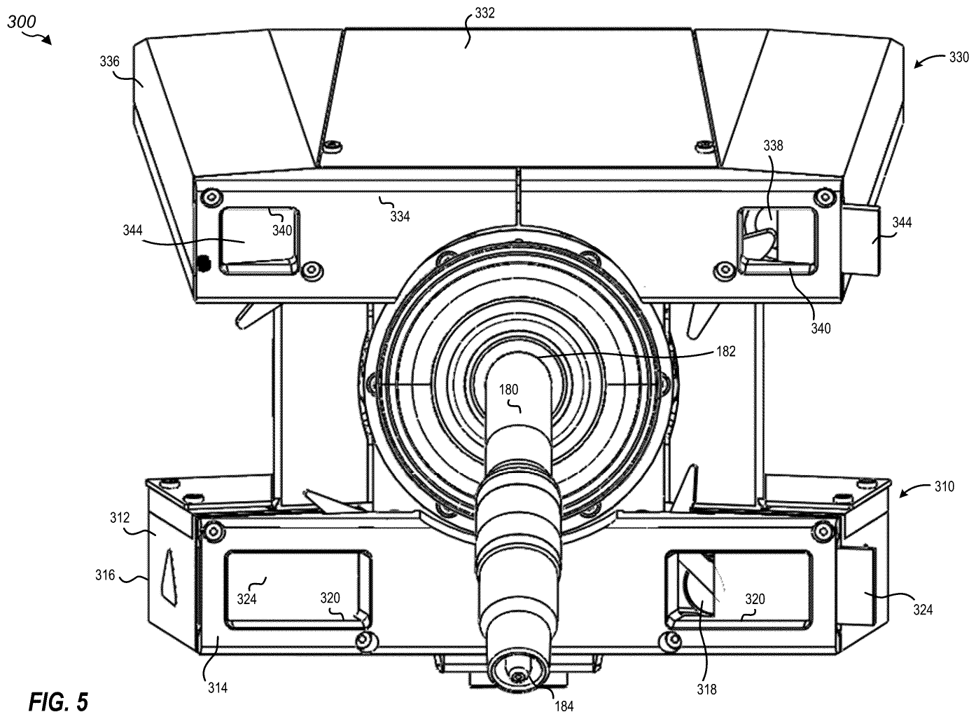

Additionally, the front end 314 of pod housing 312 defines a pair of receptacles 320 in which consumable windows 324 may be slidably inserted by an operator of local sensor unit 300. In this exemplary embodiment, consumable windows 324 are received or housed within the front end 314 of pod housing 312 (but still external the chamber 313 of housing 312) and thus are not constrained by a separate releasable fastener. Instead, consumable windows 324 may be manually slid into position (one of the windows 324 is shown partially ejected from the corresponding receptacle 320 in FIG. 5 for reference) within their corresponding receptacle 320 and into alignment with one of the transparent windows 318 formed in the front end 314 of pod housing 312. Additionally, consumable windows 324 may be of a similar configuration as the consumable windows 230 described above.

Further, pod housing 312 includes a coolant inlet 326 and a coolant outlet 327 that is spaced from the coolant inlet 326. Coolant inlet 326 and coolant outlet 327 are coupled to the coolant circulation module 360 for circulating a fluid coolant into the chamber 313 of pod housing 312 via coolant inlet 326 where the coolant may contact or otherwise receive heat from the lasers 315 located within the chamber 313 so as to cool the lasers 315 as a welding operation is performed on a workpiece by the weld head 180.

The camera pod 330 of local sensor unit 300 similarly includes an outer pod housing 332 defining an internal chamber 333 in which a plurality of high-speed cameras 335 are received. Cameras 335 may be similar in configuration to the cameras 250 described above and are configured to identify, detect, and/or monitor surface features of the workpiece during a welding operation performed by the weld head 180 including, for example, a seam of the workpiece to be welded by the weld head 180. The light projected by the lasers 315 of laser pod 310 may assist the cameras 335 in identifying and monitoring the workpiece and surface features thereof during a welding operation performed by the weld head 180.

Pod housing 332 has a first or front end 334, a second or rear end 336 opposite the front end 334. In this exemplary embodiment, similar to pod housing 312 described above, the front end 334 of pod housing 332 comprises a plurality of transparent windows 338 each aligned with a corresponding camera 335 of the camera pod 330. Transparent windows 338 are filled with a transparent material which may be of a similar configuration as the transparent material filling the transparent windows 226 and 318 described above. Additionally, the front end 334 of pod housing 332 defines a pair of receptacles 340 in which consumable windows 344 may be slidably inserted (one of the windows 344 is shown partially ejected in FIG. 5 for reference) by an operator of the local sensor unit 300 in a manner similar to which consumable windows 324 are received in the apertures 324 of laser pod 310. Consumable windows 344 may be of a similar configuration as the consumable windows 230 and 324 described above. Further, pod housing 332 includes a coolant inlet 346 and a coolant outlet 347 that is spaced from the coolant inlet 346. Coolant inlet 346 and coolant outlet 347 are coupled to the coolant circulation module 360 for circulating a fluid coolant into the chamber 333 of pod housing 332 via coolant inlet 346 where the coolant may contact or otherwise receive heat from the cameras 335 located within the chamber 333 so as to cool the cameras 335 as a welding operation is performed on a workpiece by the weld head 180.

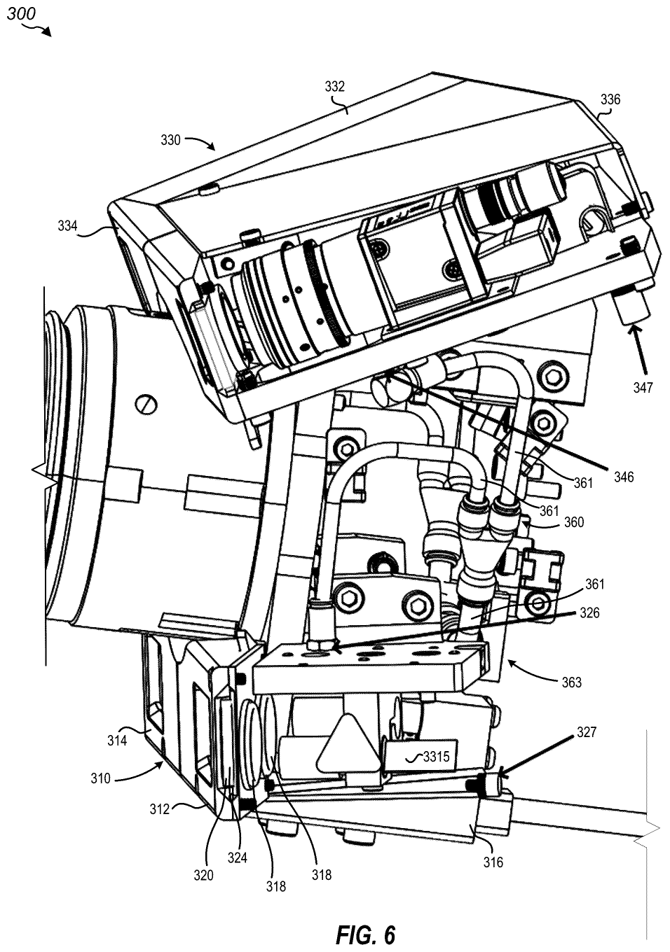

The coolant circulation module 360 of local sensor unit 300 circulates a coolant through both the chamber 313 of the pod housing 312 and the chamber 333 of the pod housing 332 to ensure neither lasers 315 of laser pod 310 nor the cameras 335 of camera pod 330 are overheated as the weld head 180 performs a welding operation on a workpiece. In this exemplary embodiment, coolant circulation module 360 comprises a plurality of coolant conduits or tubing 362 and a coolant source 364 (shown partially in FIG. 6) in fluid communication with the chambers 313 and 333 of pods 310 and 330, respectively, via the coolant tubing 362. The coolant source 364 in this exemplary embodiment pressurizes the coolant prior to supplying the coolant to the chambers 313 and 333 of pods 310 and 330, respectively. In some embodiments, coolant source 364 may also cool or otherwise condition the coolant before supplying the coolant to pods 310 and 330.

Additionally, in this exemplary embodiment, coolant source 364 comprises an air compressor configured to provide pressurized air (e.g., above ambient pressure) to the pods 310 and 330. The air is ejected to the atmosphere from the coolant outlets 327 and 347 of pods 310 and 330, respectively. However, it may be understood that in other embodiments the coolant supplied by coolant source 364 may comprise a fluid other than air and the coolant may be returned to the coolant source 364 from pods 310 and 330 rather than being ejected to the atmosphere. In other words, in this exemplary embodiment the coolant circulation module 360 is open to the environment while in other embodiments the module 360 may comprise a closed coolant loop in which the coolant is not intentionally vented to the atmosphere.

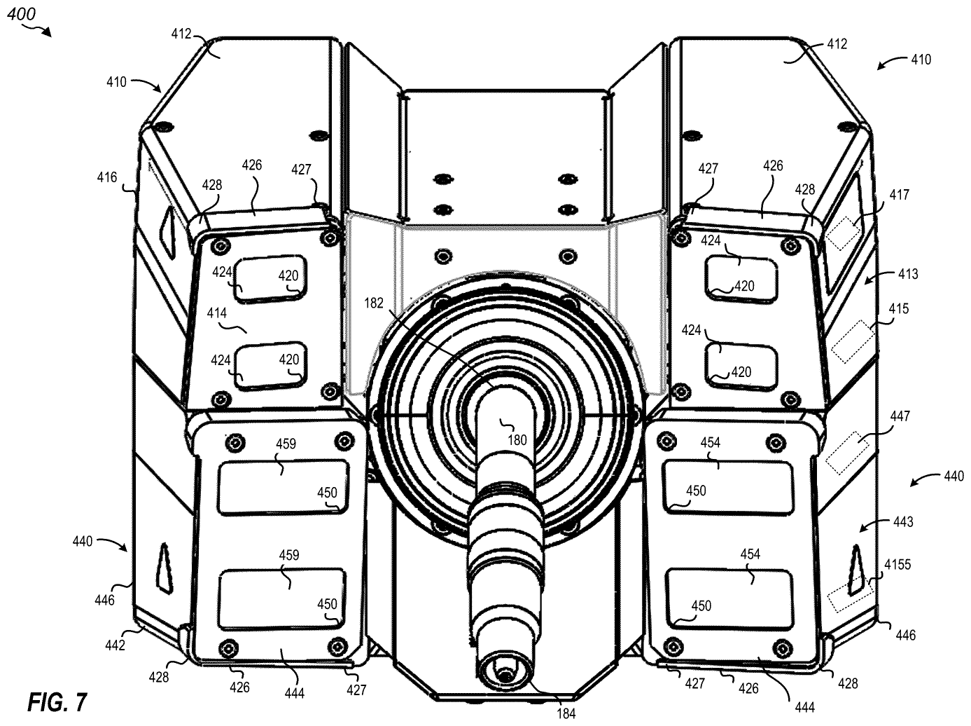

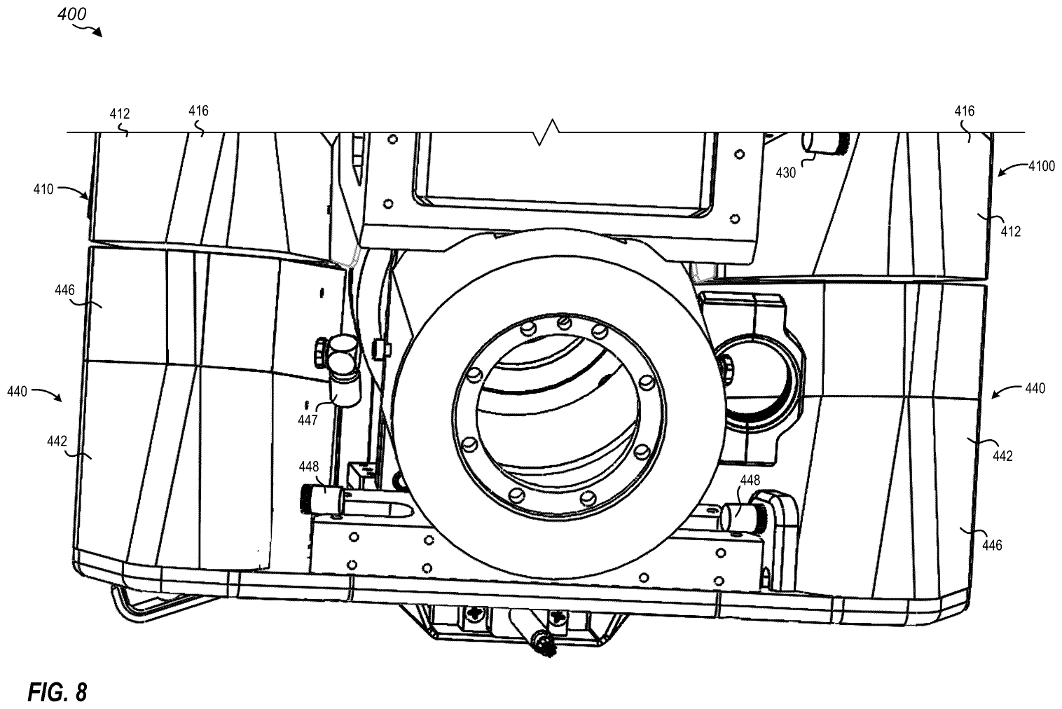

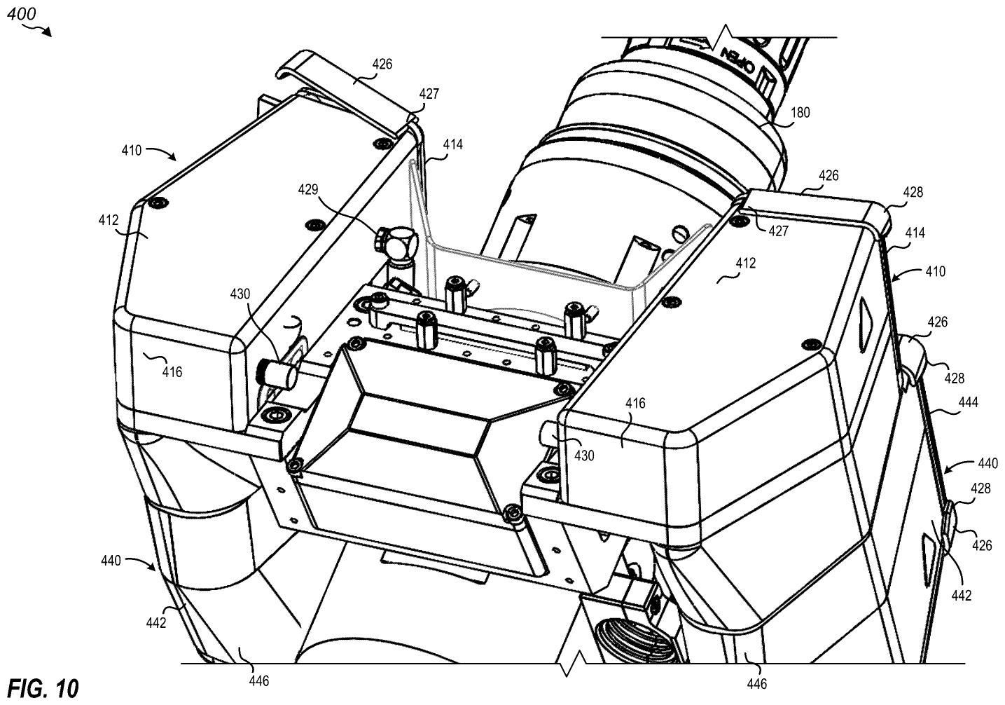

Referring to FIGS. 7-10, another embodiment of a local sensor unit 400 is shown. Local sensor unit 400 may include features in common with local sensor units 200 and 300 described above, and shared features are labeled similarly. Additionally, local sensor unit 59 of the sensor unit 50 briefly described above may be configured similarly as the local sensor unit 400 described below. In this exemplary embodiment, local sensor unit 400 generally includes a pair of upper sensor pods 410 and a pair of lower sensor pods 440. Local sensor unit 400 may include components and features not shown in FIGS. 7-10 including, for example, a coolant circulation module such a module similar in configuration to the coolant circulation module 360 described above.

Upper sensor pods 410 and lower sensor pods 440 similarly flank the weld head 180 in a stereoscopic arrangement. In this exemplary embodiment, each upper sensor pod 410 of local sensor unit 400 generally includes an outer pod housing 412 defining an internal chamber 413 in which both a laser 415 (shown schematically in outline in FIG. 7) and a high-speed, three dimensional (3D) camera 417 (shown schematically in outline in FIG. 7) is received. While in this exemplary embodiment upper sensor pods 410 include laser 415 and 3D camera 417, it may be understood that pods 410 may include additional sensors not shown in FIGS. 7-10. Additionally, in some embodiments, upper sensor pods 410 may not include laser 415 and/or 3D camera 417.

In this exemplary embodiment, 3D camera 417 is arranged vertically above the laser 415 within the chamber 413 of pod housing 412. Laser 415 may be similar in configuration to the lasers 206 and 315 described above.

The pod housing 412 of each upper sensor pod 410 has a first or front end 414, a second or rear end 416 opposite the front end 414. In this exemplary embodiment, the front end 414 of pod housing 412 comprises a pair of vertically stacked windows (not shown in FIGS. 7-10) aligned with the laser 415 and 3D camera 417. The transparent windows of pod housing 412 are filled with a transparent material which may be of a similar configuration as the transparent material filling the transparent windows 226 described above.

Additionally, the front end 414 of pod housing 412 defines a single vertically extending receptacle 420 in which a pair of vertically stacked consumable windows 424 may be slidably inserted by an operator of the local sensor unit 400. Consumable windows 424 may be similar in configuration to the consumable windows 230 and 324 described above. In this exemplary embodiment, the pod housing 412 comprises a closure member or tab 426 at the front end 414 thereof. In this exemplary embodiment, closure tab 426 comprises a first or pivot end 427 pivotably connected at a hinge or pivot joint to the pod housing 412, and a second or free end 428 opposite the pivot end 427 and which is permitted to pivot about the pivot joint relative to the pod housing 412. While in this exemplary embodiment the closure tab 426 pivots relative to the pod housing 412, it may be understood that closure tab 426 may move or transition relative to the pod housing 412 in a variety of ways in other embodiments.

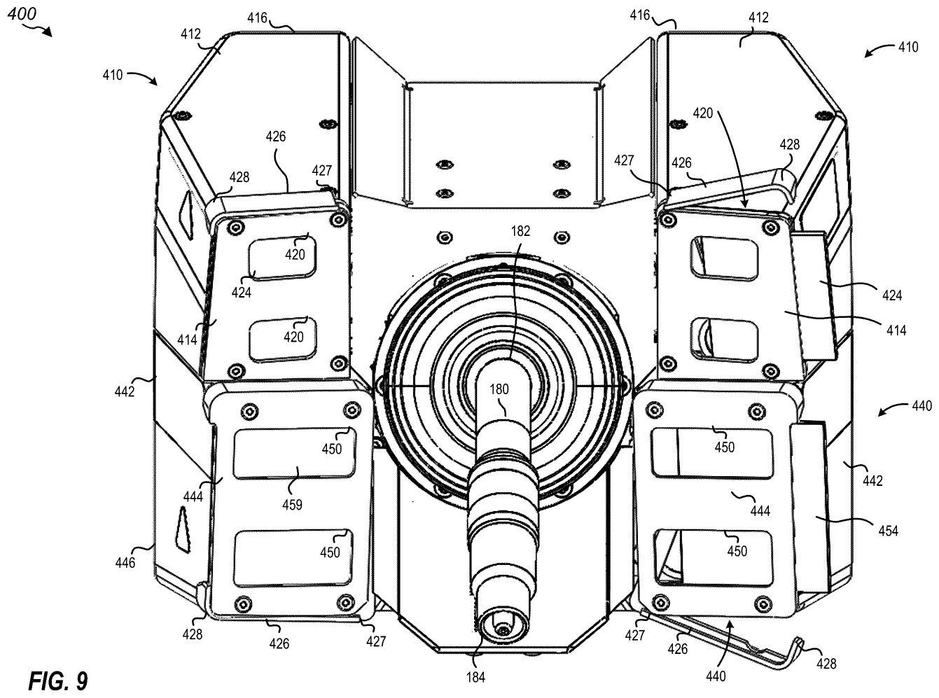

The closure tab 426 of each upper sensor pod 410 is permitted to move relative to the pod housing 412 and includes a closed position (shown in FIG. 7) which encloses the receptacle 420 from the external environment, and an open position (shown to the right of weld head 180 in FIG. 9) which exposes the receptacle 420 to the surrounding environment and permits one or more consumable windows 424 to be inserted into the receptacle 420 in a vertically stacked arrangement. While in this embodiment a pair of consumable windows 424 are receivable in the receptacle 420, in other embodiments, a single consumable window 424 or more than two windows 424 may be inserted into receptacle 420 in different arrangements (e.g., vertically stacked, side-by-side, etc.).

In some embodiments, the closure tab 426 may be locked into the closed configuration by a locking member to prevent the closure tab 426 from inadvertently opening during the operation of local sensor unit 400 such as when weld head 180 is engaged in welding a workpiece. For example, a separate fastener may be inserted through an aperture formed in the closure tab 426 and the pod housing 412 to secure the tab 426 to the housing 412 and prevent relative movement therebetween. As another example, a snap fitting or connector of the closure tab 426 itself (e.g., a snap connector formed on the free end 428 of closure tab 426) may snap into a corresponding fitting or recess formed on the pod housing 412 to secure the tab 426 to the housing 412 and prevent relative movement therebetween.

In this exemplary embodiment, the pod housing 412 of each upper sensor pod 410 additionally includes a coolant inlet 429 and a coolant outlet 430 that is spaced from the coolant inlet 429. Coolant inlet 429 and coolant outlet 430 are coupled to a coolant circulation module such as a coolant circulation module similar in configuration to the coolant circulation module 360 described above. In this manner, a fluid coolant may be circulated into the internal chamber 413 of pod housing 412 via coolant inlet 429 where the coolant may contact or otherwise receive heat from the laser 415 and 3D camera 417 located within the chamber 413 so as to cool the laser 415 and 3D camera 417 as a welding operation is performed on a workpiece by the weld head 180.

In this exemplary embodiment, lower upper sensor pod 440 of local sensor unit 400 generally includes an outer pod housing 442 defining an internal chamber 443 in which both a pair of lasers 415 (shown schematically in outline in FIG. 7) and a high-speed, two dimensional (2D) camera 448 (shown schematically in outline in FIG. 7) are received. While in this exemplary embodiment lower sensor pods 440 include a pair of lasers 415 and 2D camera 448, it may be understood that pods 440 may include additional sensors not shown in FIGS. 7-10. Additionally, in some embodiments, lower sensor pods 440 may not include laser 415 and/or 2D camera 448.

In this exemplary embodiment, the pair of lasers 415 are positioned horizontally adjacent each other while the 2D camera 448 is arranged vertically above the pair of lasers 415 within the chamber 443 of pod housing 442.

The pod housing 442 of each lower sensor pod 440 has a first or front end 444, a second or rear end 447 opposite the front end 444. In this exemplary embodiment, the front end 444 of pod housing 442 comprises a pair of vertically stacked windows (not shown in FIGS. 7-10) aligned with the pair of lasers 415 and 2D camera 448. The transparent windows of pod housing 442 are wider than the transparent windows of the pod housing 412 of upper sensor pods 410 to account for the pair of horizontally arranged lasers 415 and is filled with a transparent material which may be of a similar configuration as the transparent material filling the transparent windows 226 described above.

Additionally, the front end 444 of pod housing 442 similarly defines a single vertically extending receptacle 450 in which a pair of vertically stacked consumable windows 454 may be slidably inserted by an operator of the local sensor unit 400. Consumable windows 454 may be similar in configuration to the consumable windows 230 and 324 described above. Additionally, consumable windows 454 are wider than the consumable windows 424 described above to account for the pair of lasers 415 housed within the internal chamber 443 of the pod housing 442. In this configuration, a longitudinal axis of each laser 415 and the 2D camera 448 extends through and intersects one of the pair of consumable windows 454 installed in the receptacle 450.

In this exemplary embodiment, the pod housing 442 comprises a closure tab 426 at the front end 444 thereof. Similar to the pod housing 412 of each upper sensor pod 410, the pivot end 427 of closure tab 426 is pivotably connected to the pod housing 442 such that the free end 427 of closure tab 426 is permitted to move relative to the pod housing 442 and includes a closed position (shown in FIG. 7) which encloses the receptacle 450 from the external environment, and an open position (shown to the right of weld head 180 in FIG. 9) which exposes the receptacle 450 to the surrounding environment and permits one or more consumable windows 454 to be inserted into the receptacle 450 in a vertically stacked arrangement. It may be understood that while in this embodiment a pair of consumable windows 454 are receivable in the receptacle 450, in other embodiments, a single consumable window 454 or more than two windows 454 may be inserted into receptacle 450 in different arrangements (e.g., vertically stacked, side-by-side, etc.). As with upper pods 410, the closure tab 426 of each lower pod 440 may be locked into the closed configuration by a locking member to prevent the closure tab 426 from inadvertently opening during the operation of local sensor unit 400 such as when weld head 180 is engaged in welding a workpiece.

Additionally, in this exemplary embodiment, the pod housing 442 of each lower sensor pod 440 includes a coolant inlet 447 and a coolant outlet 448 that is spaced from the coolant inlet 447. Coolant inlet 447 and coolant outlet 448 are coupled to a coolant circulation module such as a coolant circulation module similar in configuration to the coolant circulation module 360 described above. In this manner, a fluid coolant may be circulated into the internal chamber 443 of pod housing 442 via coolant inlet 447 where the coolant may contact or otherwise receive heat from the pair of lasers 415 and 2D camera 448 located within the chamber 443 so as to cool the pair of lasers 415 and 2D camera 448 as a welding operation is performed on a workpiece by the weld head 180. In some embodiments, the chambers 443 of the lower sensor pods 440 along with the chambers 413 of the upper sensor pods 410 may each be in fluid communication with a common or shared pressurized coolant source of a coolant circulation module 360.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A manufacturing cell for welding a workpiece, the manufacturing cell comprising:
a sensor pod configured to be coupled to a weld head, the weld head configured to weld the workpiece and to be coupled to a terminal end of a robotic arm such that the weld head is permitted to travel relative to a base of the robotic arm, wherein the robotic arm extends between the base and the terminal end, and wherein the sensor pod comprises:
an outer pod housing defining an internal chamber extending between a front end and a rear end of the pod housing, and wherein the front end of the pod housing defines a receptacle;
a sensor positioned in the internal chamber of the pod housing, the sensor configured to provide sensor feedback associated with the workpiece; and
a consumable window comprising a transparent material is insertable into the receptacle such that a longitudinal axis of the sensor intersects the consumable window when the consumable window is inserted into the receptacle.

2. The manufacturing cell of claim 1, wherein the sensor pod is coupled to the weld head such that the sensor pod is configured to travel in concert with the weld head relative to the base of the robotic arm.

3. The manufacturing cell of claim 2, wherein the longitudinal axis projects from the sensor of the sensor pod towards a terminal end of the weld head.

4. The manufacturing cell of claim 1, wherein the sensor pod includes a camera configured to record imaging data of the workpiece, and wherein the sensor pod is coupled to a laser pod comprising a laser which is configured to project a light onto the workpiece.

5. The manufacturing cell of claim 1, wherein the sensor pod comprises a retainer coupled to the front end of the pod housing and configured to retain the consumable window in the receptacle.

6. The manufacturing cell of claim 5, wherein the retainer of the sensor pod comprises a spring clip having a first end coupled to the front end of the pod housing and a free end, opposite the first end, that is permitted to flex outwardly from the front end of the pod housing.

7. The manufacturing cell of claim 6, wherein the retainer of the sensor pod comprises a closure tab having a first end pivotably coupled to the front end of the pod housing and a free end, opposite the first end, configured to rotate relative to the pod housing.

8. The manufacturing cell of claim 1, wherein the sensor pod comprises a spray nozzle coupled to the front end of the pod housing, the spray nozzle configured to direct a flow of fluid towards the consumable window when the consumable window is inserted in the receptacle.

9. The manufacturing cell of claim 1, wherein the front end of the pod housing comprises a transparent window comprising a transparent material, and wherein the transparent window is positioned between the sensor and the consumable window along the longitudinal axis when the consumable window is inserted in the receptacle.

10. The manufacturing cell of claim 1, wherein the consumable window of the sensor pod is removably insertable into the receptacle of the pod housing.

11. The manufacturing cell of claim 1, wherein the sensor pod comprises a plurality of the consumable windows, each removably insertable into the receptacle of the pod housing.

12. The manufacturing cell of claim 1, wherein the receptacle of the sensor pod is external to the internal chamber of the pod housing.

13. The manufacturing cell of claim 1, further comprising a coolant circulation module comprising a coolant source and one or more fluid conduits coupled between the coolant source and a coolant inlet of the pod housing of the sensor pod whereby fluid communication is provided between the coolant source and the internal chamber of the pod housing, wherein the coolant circulation module is configured to circulate a coolant from the coolant source, through the one or more fluid conduits, and into the internal chamber of the pod housing via the coolant inlet.

14. A manufacturing cell for welding a workpiece, the manufacturing cell comprising:
a sensor pod configured to be coupled to a weld head, the weld head configured to weld the workpiece and to be coupled to a terminal end of a robotic arm such that the weld head is permitted to travel relative to a base of the robotic arm, wherein the robotic arm extends between the base and the terminal end, wherein the sensor pod comprises:
an outer pod housing defining an internal chamber extending between a front end and a rear end of the pod housing, the pod housing comprising a coolant inlet in fluid communication with the internal chamber; and
a sensor positioned in the internal chamber of the pod housing, the sensor configured to provide sensor feedback associated with the workpiece; and
a coolant circulation module comprising a coolant source and one or more fluid conduits coupled between the coolant source and the coolant inlet of the pod housing of the sensor pod whereby fluid communication is provided between the coolant source and the internal chamber of the pod housing, wherein the coolant circulation module is configured to circulate a coolant from the coolant source, through the one or more fluid conduits, and into the internal chamber of the pod housing via the coolant inlet.

15. The manufacturing cell of claim 14, wherein the pod housing of the sensor pod comprises a coolant vent in fluid communication with the internal chamber, and wherein the coolant vent is configured to vent fluid from the internal chamber into the atmosphere.

16. The manufacturing cell of claim 14, further comprising a plurality of the sensor pods each coupled to the weld head, and wherein the coolant source of the coolant circulation module is in fluid communication with the internal chamber of each of the plurality of sensor pods.

17. The manufacturing cell of claim 14, wherein the sensor pod is coupled to the weld head such that the sensor pod is configured to travel in concert with the weld head relative to the base of the robotic arm.

18. The manufacturing cell of claim 17, wherein the longitudinal axis projects from the sensor of the sensor pod towards a terminal end of the weld head.

19. The manufacturing cell of claim 14, wherein the sensor pod includes a camera configured to record imaging data of the workpiece, and wherein the sensor pod is coupled to a laser pod comprising a laser which is configured to project a light onto the workpiece.

20. The manufacturing cell of claim 14, wherein the front end of the pod housing of the sensor pod defines a receptacle, and the sensor pod further comprises a consumable window comprising a transparent material is insertable into the receptacle such that a longitudinal axis of the sensor intersects the consumable window when the consumable window is inserted into the receptacle.

21. The manufacturing cell of claim 20, wherein the sensor pod comprises a window retainer coupled to the front end of the pod housing and configured to retain the consumable window in the receptacle.

22. The manufacturing cell of claim 14, further comprising one or more artificial light sources coupled to the sensor pod, wherein the controller is configured to operate the one or more artificial light sources.

23. The manufacturing cell of claim 14, further comprising a controller coupled to the sensor pod and configured to operate at least one of the robotic arm and the weld head based on the sensor feedback provided by the sensor of the sensor pod.
